(19) United States
(12) Patent Application Publication
(10) Pub. No.: US 2023/0036640 A1
(43) Pub. Date: Feb. 2, 2023

(54) LOW TEMPERATURE RECIPROCATING PUMP

(71) Applicant: RIEKE PACKAGING SYSTEMS LIMITED, Leicester Leicestershire (GB)

(72) Inventors: Gaurang MITTAL, Uttar Pradesh (IN); Simon Christopher KNIGHT, Bridgend South Wales (IN); Manuj SHARMA, Leicestershire (IN)

(21) Appl. No.: 17/789,821

(22) PCT Filed: Dec. 31, 2020
(86) PCT No.: PCT/EP2020/088084

§ 371 Date: Jun. 29, 2022

(30) Foreign Application Priority Data
Dec. 31, 2019 (IN) 201941054651

(51) Int. Cl. B05B 7/00; B05B 11/00

(52) U.S. Cl. CPC B05B 7/005; B05B 11/0005; B05B 11/3087

(57) ABSTRACT

A reciprocating foamer pump avoids problems encountered when conventional foamer pumps are exposed to freezing temperatures. In particular, the inventive pump provides an extra-secure connection between air and liquid piston members (200,300). Additionally, a tortuous air inlet (210) is provided to the foamer chamber (136) so as to prevent melted liquid from draining and accumulating in the air chamber.

### CROSS REFERENCE TO RELATED APPLICATIONS

This application claims the priority of and all benefits from Indian patent application 201941054651 filed on Dec. 31, 2019.

### TECHNICAL FIELD

The present invention relates to fluid dispensers and, more particularly, to an improved pump design that allows for detection and user intervention to avoid damage to a reciprocating pump in which ice may have formed.

### BACKGROUND

Dispensing pumps have found widespread use in a wide range of industries, including personal care products, food and beverage service, and a variety of other commercial and industrial settings. Within this category, foamers (foam dispensers) are particularly useful because the foam allows for delivery of the product by mixing ambient air with a liquid form of the dispensed product. Further, consumers and users may prefer foams over pure liquids for certain products.

Foaming products are increasingly being sold directly to consumers, thereby requiring shipment of the product in its dispenser. Such “e-commerce” shipping gives rise to a variety of scenarios in which the dispenser pump (and the product it contains) will be exposed to freezing temperatures for prolonged periods of time. Separately, use of foaming products may leave dispensing pumps and containers in freezing conditions. In any of these cases, the potential for liquid products freezing within the pumping mechanism of the container can create significant problems.

An example of a conventional foaming pump 10 is shown in FIG. 1, and demonstrates some generic features of foam dispensers also relevant for the present proposals. Generally speaking, actuator head 20 is attached to a pump engine 30. Engine 30 includes an air piston 32 and liquid piston 34 acting respectively in air cylinder and liquid cylinder portions of a cylinder body of the pump engine, to feed their respective fluids into a foaming chamber 36. A biasing member 40 cooperates with reciprocating force provided by a user (e.g., pressing down on the actuator 20). Suction is created as the biasing member 40 returns the actuator 20 and engine 30 to their original/resting positions. In turn, the reciprocating forces provide suction to move fluids through the engine 30 and, ultimately, expel foam out of an outlet 22 in the actuator 20.

The operation of pump 10 can be negatively impacted by low temperatures. In particular, liquid product can freeze within the foaming chamber 36, thereby blocking the air and/or liquid inlets and outlets both within the chamber 36 and elsewhere within engine 30. These blockages can create compressed trapped air that exerts sufficient force to separate the pistons 32, 34 (which would destroy the continued functionality of the pump 10). At best, these blockages will prevent reciprocation of the pump 10, but when the pump 10 is brought above freezing, the melted liquid tends to drain into and accumulate within the air chamber 33 via the air inlets so as to negatively impact the continued functionality of the pump 10.

Other examples of known, conventional foamer pumps include U.S. Pat. Nos. 9,962,723; 9,724,714; 8,496,142; 8,490,833; 7,850,048; and 6,536,629, as well as Japanese Patent JP5131754B2. The background discussion and exemplary disclosures of conventional foamer pump designs from all of these documents are incorporated by reference as further context for the disclosed invention herein.

Therefore, a foaming pump design capable of withstanding temperature cycling (i.e., multiple/repeated freeze-thaw cycles) without negatively impacting the functionality of the pump would be welcome.

### SUMMARY

The disclosed foamer pump includes a strengthened, secure connection between the air and liquid pistons, combined with a tortuous air inlet to the mixing chamber to ensure melt liquid collecting within that chamber drains back through the liquid inlet. Also, serrations or formations along the liquid inlet deter frozen chunks from being drawn into the engine. This combination of features ensures that the pump cannot be reciprocated when liquid is frozen within the foaming chamber and, when liquid within the foaming chamber melts, it will not drain into and/or accumulate within the air chamber.

Aspects of our proposals are set out in the claims. In one aspect a foam dispenser comprises a reciprocable actuator having a head and a stem which extends along a reciprocating axis of the dispenser, and has an outlet for dispensing foam. A pump body coaxially receives at least a portion of the stem. The actuator includes a liquid piston member, with an axial passage therein for outflow of liquid, and an air piston member coaxially receiving and attached to a top portion of the liquid piston member. A liquid outlet valve function may be provided e.g. by a piston rod coaxially received within the axial passage of the liquid piston. The liquid piston member comprises a liquid piston and the air piston member comprises an air piston. A pump cylinder component has portions defining a liquid chamber and an air chamber, encasing the liquid piston and the air piston respectively and permitting the liquid piston and the air piston to move axially within the pump cylinder along the reciprocating axis. A foaming chamber is defined by interfacing surfaces of the air piston member and the liquid piston member where these are connected together. The foaming chamber has a liquid inlet and an air inlet positioned proximate to a foaming element such as one or more mesh inserts e.g. as known. The air chamber is defined by the pump cylinder and varies in volume in response to axial movement of the air piston. A valve member is captured between the liquid piston member and the air piston member, and is adapted to admit air from the air chamber to the air inlet of the foaming chamber along a tortuous passage defined by the interface of the air piston member and the top portion of the liquid piston member. In one specific proposal herein the tortuous passage includes an apex, said apex being at a higher axial elevation than either the liquid inlet or the air inlet of the foaming chamber. This can prevent any fluid accumulating in the foaming chamber from flowing back into the air chamber.

Specific reference is made to the appended claims, drawings, and description below, all of which disclose elements and aspects of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings, which are incorporated as part of this disclosure:

FIG. 1 is a cross sectional side view of a conventional pump mechanism.

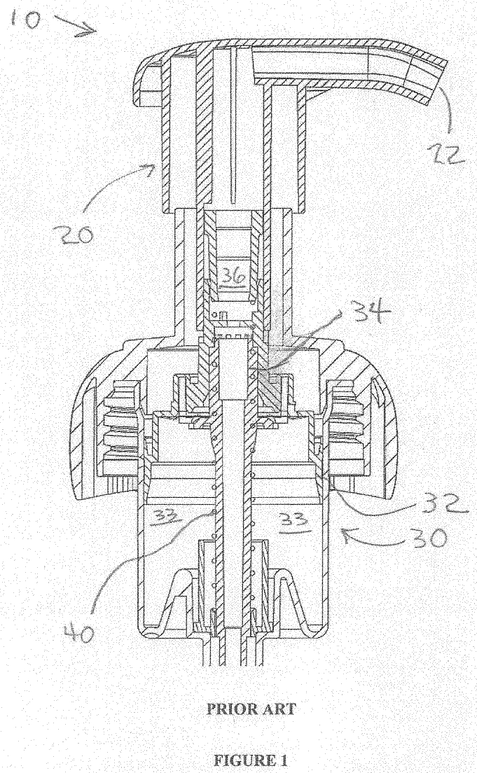

FIG. 2A is a cross sectional side view of one aspect of the pump having a mesh insert proximate to the inlet of the pump mechanism, while FIG. 2B is a partial, enlarged view of part of FIG. 2A, so as to highlight the tortuous flow path of air from the air chamber into the foamer/mixing chamber.

FIG. 3A is a three dimensional partial view of the top portion of the liquid piston, highlighting the locking formations. FIG. 3B is a cross sectional side view of part of FIG. 3A.

FIG. 4 is a three dimensional view of the air piston underside (i.e., the facing which interfaces and connects to the liquid piston).

FIG. 5 is an isolated, cross sectional view of the air and liquid pistons assembled together, including the diaphragm/valve positioned therebetween.

FIG. 6A is a three dimensional partial view of the bottom portion of pump engine housing (or a corresponding piece fitted to the inlet of the pump engine), highlighting the blocking projections. FIG. 6B is a bottom view of the same.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Any descriptions and drawings in this disclosure, and any written matter within the drawings, should be deemed to be reproduced as part of this specification. Unless noted to the contrary, all measurements are with reference to ambient temperature and pressure relying on industry-standard tests (e.g., protocols published by relevant trade and technical organizations, including the American Standard Test Methods, etc.), while appropriate percentages or ratios are with reference to weight unless context dictates to the contrary.

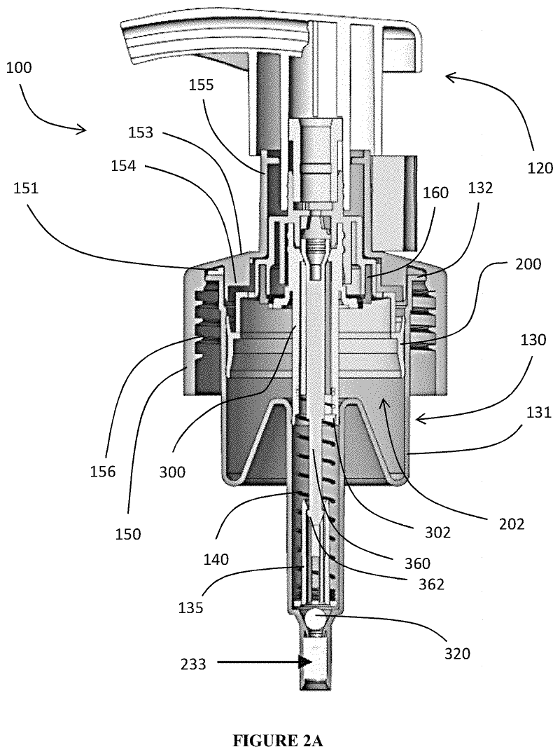

As seen in FIGS. 2A through 6B, a foamer pump 100 is contemplated. As with conventional foamers, actuator 120 is affixed to an engine 130, with a biasing member 140—a coil spring is shown—urging the air piston member 200 up away from the liquid piston member 300. A valve member 160 is captured between the piston members 200, 300 to selectively allow airflow between the members and/or with the ambient environment by providing for a flexible, resilient barrier to selectively control flow of fluids through apertures positioned proximate to and covered by respective wings or flaps 161, 163 of valve member 160.

Engine 130 is defined by an outer cylinder 131, into which the piston members 200, 300 are coaxially fitted. Sealing flange 132 at the top edge of cylinder 131 cooperates with a groove 151 formed in a closure cap 150. Notably, the closure cap 150 forms a top exterior surface of the pump 100 while simultaneously providing for threads or other attachment means 156 on an inner facing of cap 150, preferably proximate to a gap defined by skirt or sidewall 152 on an outer edge and the outer facing of cylinder 131. The top or horizontal panel 153 of cap 150 may have stepped formations 154 which conform to surfaces on the air piston 200, thereby defining uppermost stops for the movement of the piston members 200, 300.

An open, cylindrical stem 155 may be integrally formed in the panel 153 to receive portions of the actuator 120 and/or engine 130. Rotational and/or axial movement locking members may be formed in or between the cap 150, the actuator 120, and/or the engine 130.

Cylinder 131 defines an air chamber 202 that fluidically connects to the foamer/mixing chamber 136 of the engine 130 by way of tortuous passage(s) 210 (traced by an arrow in FIG. 2B and further described below). Piston member 200 moves axially up and down within chamber 202 in response to biasing force from member 140 and/or force exerted on the actuator 120 by the user. Wiper elements or wings 220 sealingly engage the inner surfaces of cylinder 131 so that the volume of air in the lower portion of chamber 202 (i.e., the variable space beneath the piston 200 and the bottom end of cylinder 131) varies. They constitute a seal of the air piston. The upper space of chamber 202 communicates with the ambient environment via one or more ports within the cap 150 and/or the interstices provided between the cap 150 and the container to which it is affixed.

Wipers 220 connect to a cup-shaped annular member 230 of the air piston member 200. Member 230 includes step-like formations that conform to the steps 154 on panel 153 as noted above (and as seen in FIGS. 2A and 2B). One or more ports 231, preferably oriented on an upper facing and formed integrally within the step-like formations, allow for airflow through the air piston 200, subject to the further action of valve 160.

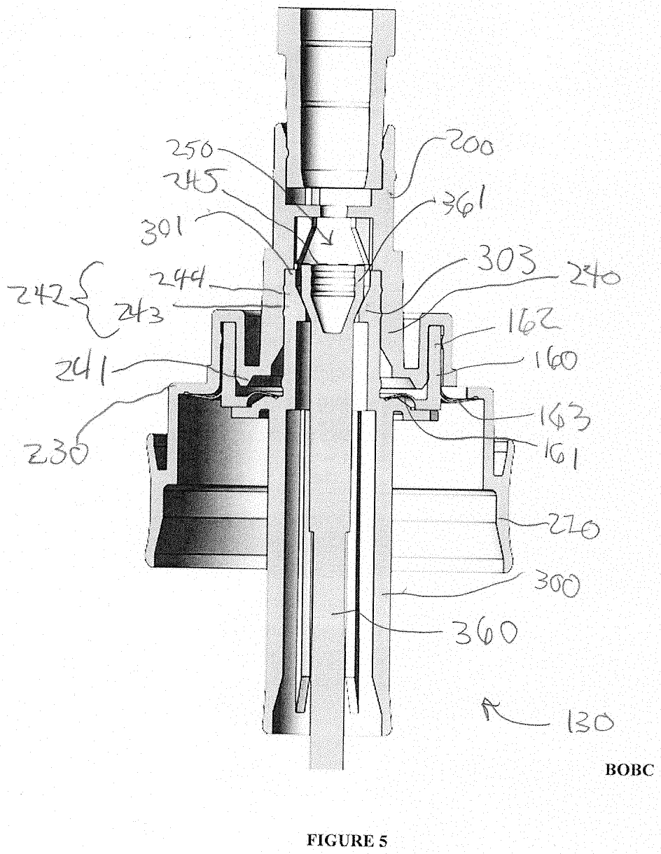

Additionally, a pair of coaxial cylinders 240, 241 (FIG. 5) extend downward from cup-shaped member 230 along its central axis so as to receive and connect to the liquid piston member 300. A series of formations 242, such as beads or grooves, are formed on an inner facing of cylinder 240, which forms a socket as shown. Formations 242 cooperate with corresponding formations 342 on the liquid piston member 300 as described below so as to snap fit and connect the piston members 200, 300. These formations 242, 342 provide a sufficiently strong connection of piston members 200, 300 to avoid disassembly owing to air pressure if the outlet of actuator 120 is blocked (e.g., by ice obstructing the outflow from foamer/mixing chamber 136). The connection may be further augmented by adhesive or other conventional means, although formations 242, 342 should be sufficient in their own right.

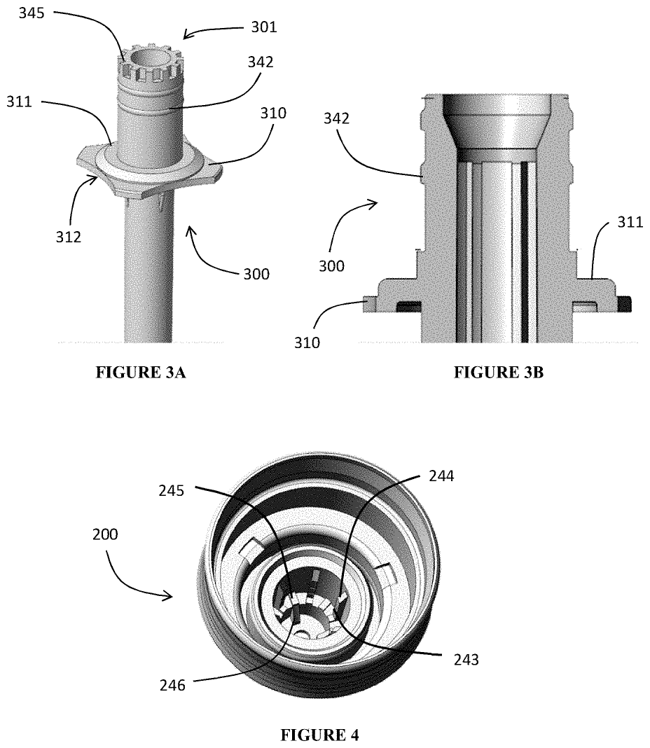

An upper cylinder or receiving port 250 on the top facing of cup-shaped member 230 (i.e., extending above the step-like formations) defines or connects to the foamer/mixing chamber 136. Support fins 246 may gird the upper flange/panel of the chamber 136, as well as serve as a guide or stopper for the upward movement of a piston rod 360: see FIGS. 4 and 5. Specifically, the portions of actuator 120 (e.g., a flowpath defining cylinder 121) connects to the port 250 to define the chamber 136. A mesh insert is provided in or proximate to the outlet of chamber 136 so that air and liquid mixing in the chamber 136 are forced through the mesh to create foam, as is well-known in this field. Generally speaking, the connection between the actuator 120 and engine 130 must accommodate the reciprocating action of the respective elements. Coaxially aligned vertical cylinders on the actuator 120, engine 130 (e.g., as part of chamber 136), and/or cap 150 fit together within appropriately sized gaps to accomplish these means.

Chamber 136 can be formed as a discrete tube. In such cases, grooves, flanges, or gaps can be formed on the actuator 120 and/or port 250 to receive such a tube. Foaming mesh can be captured at any point in these arrangements.

As seen in FIG. 4, formations 242 may be formed as a series of partially circumferential beads and/or ridges 243 arranged/offset by axially aligned flanges 244. Formations 342 are sized to receive and couple to these beads/ridges 243. Fins or castellations 245, 345 can also be provided along the interface between pistons 200, 300 to limit rotational movement and/or create an axial offset defining portions of passageway 210 proximate to the apex of the tortuous path. As such, the castellations are cooperatingly sized flanges of alternating axial heights, sized so that the peak of one fits into the valley of another, whereby the axial heights and/or radial widths of individual fins or castellations on one element are varied relative to one another so as to leave a gap or gaps when fitted/mated to corresponding valleys on the opposing piece.

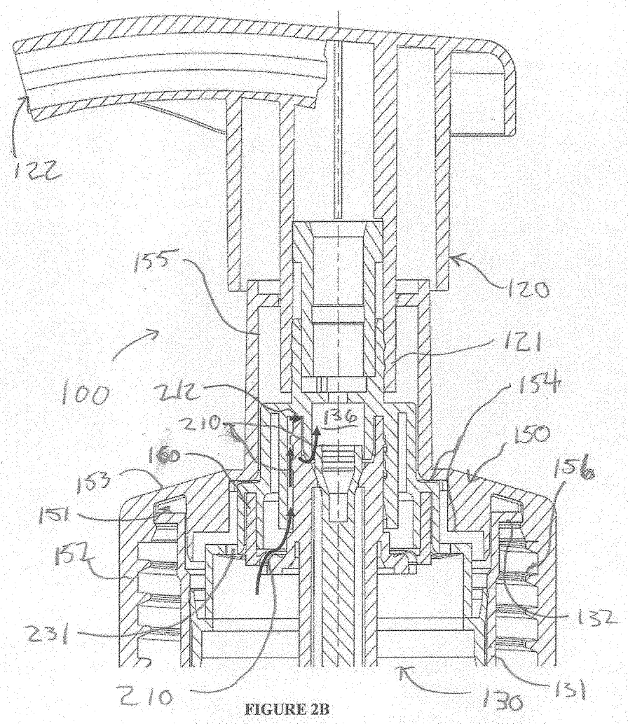

Liquid piston member 300 includes a top portion 301 as shown in FIGS. 3A and 3B. The lower portions connects liquid inlet port 302 formed at the end opposite to portion 301 (not shown in FIG. 3A but visible in FIG. 2A). As shown, this is where the lower portion forms a piston acting in a lower liquid cylinder portion of the pump cylinder. Port 302 connects to the portion of engine 130 (e.g., a dip tube or lower extension) that is positioned within the internal volume of a container which incorporates the liquid product to be converted into foam by pump 100. Port 302 can also be formed to serve as an upper seat for biasing member 140.

An axial shaft is hollowed out through the central portion of liquid piston member 300. Proximate to top portion 301, this shaft may include a tapered and/or frustoconical section 303 that serves as a rest and stopper for arms or end enlargement 361 protruding from the top of piston rod 360. Section 303 may also protrude radially inward from a wall section having a smaller inner diameter in comparison to the inner diameter proximate port 302.

Top 301 includes formations 342 on an exterior facing as described above. Annular engagement flange 310 extends radially outward below formations 342. Flange 310 may be curved or inwardly scalloped along edge 312 to create a gap between the pistons 200, 300 that is sealed by valve 160. A step-like disc 311 can be formed on the top facing of the flange 310 and serves as a sealing surface for valve 160.

Flange 310 may be in contact with a movable flap of valve 160 so as to control the flow of air into passage 210. It constitutes an air outlet valve leading to passage 210. Notably, valve member 160 has a T- or L-shaped cross-section, so that the flap portion 161 in contact with flange 310 moves while the axial wall 162 is captured in a gap between member 230 and cylinder 241. Ideally, valve 160 has two flaps 161, 163, the first flap 161 admitting air into the mixing chamber on one side of thickened axial wall 162 and the second flap 163 controlling flow of ambient air into the air chamber to minimize or eliminate pressure differentials caused by repeated actuation of the pump (i.e., dispensing of liquid out of the container as foam).

The interface between air piston member 200 and liquid piston member 300 defines one or more tortuous air flow passages 210, as indicated by the arrows in FIG. 2B. The connection of these elements provide a spaced arrangement to fluidically connect and define the passage 210. The passage 210 has a tortuous presentation, with at least two different changes in direction, more preferably at least three, and possibly even more. Further, the apex 212 of the passage 210 resides at an axial elevation or higher level in comparison to where air enters the port 250 (i.e., the point at which air is admitted to the central-most axis that defines the straight line that liquid moves along through the liquid piston 300). In practice, the air inlet to the mixing chamber 136 is an offset space between the air piston 200 and the liquid piston 300 (i.e., the same interstice which defines tortuous flowpath 210).

Appropriate valves 320 are positioned along the liquid flowpath to ensure suction is created. In particular, inlet valve 320 may be a ball valve, flap, or other appropriate means. An outlet valve for liquid may be integrated within or proximate to the liquid piston 300, such as by provision of the specially-shaped piston rod 360. In this manner, the inlet valve 320 is displaced and liquid is drawn into the hollow portion of the piston 300 as the actuator moves upward. Upon the next downstroke, the liquid trapped in that space displaces the outlet valve and is pushed upward into the chamber 136 to form foam (when mixed with air therein) that is dispensed through the outlet 122.

In this context, a “tortuous” flowpath will have a curved or bending shape, such as an inverted U, M, or other complex and/or curving shape in which the flowpath has an apex bounded on either side by an inflow connecting to the air chamber on one side and an outflow connecting to the foamer chamber on the opposing side. The total cumulative volume of the outflow equals or exceeds at least the amount of liquid expected to enter the foamer/mixing chamber on a single dispensing stroke. In a further embodiment, the volume of the outflow might equal or exceed the total volume of the foamer/mixing chamber. In a further embodiment, the volume of the outflow is designed to accommodate the expected about of liquid that might freeze within the chamber at a specified temperature.

The volume of the outflow may be adjusted in a number of ways. A plurality of separate ducts, having the same or differing tortuous paths, may be employed. The width and/or length of the outflow also impacts the volume. Notably, notwithstanding the reference to an inverted U or other shapes, the inflow and outflows do not need to be mirror images. Indeed, the axial elevation (i.e., from its entry/exit point up to the apex) of each can be manipulated to further impact the volume of the outflow channel(s), as the inflow can have a different path length and/or volume. The most significant feature is to ensure the apex is positioned sufficiently high enough (relative to the axial height of the pump) so that liquid melting within the chamber 136 remains trapped in the chamber and/or flows back down through the liquid flowpath for the foamer/mixing chamber. This prevents accumulation of melted liquid within the air chamber 202.

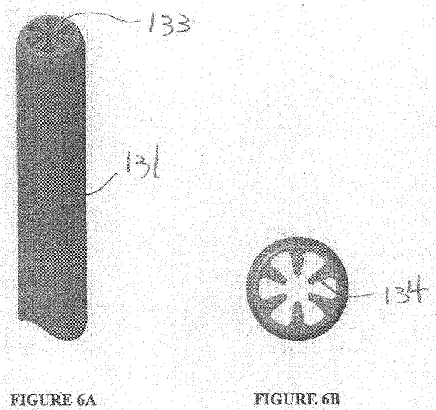

The blocking projections 133 shown in FIGS. 6A and 6B are merely exemplary. Projections 133 may be formed integrally as part of the lower portions of cylinder 131 or as part of a discrete dip tube attachment fitted to the pump engine 130. While a uniform plurality of inwardly directed fingers 134 (e.g., four, six, or eight) is expected to have particular utility, other arrangements and other structures could be employed. Any number of fingers can be arranged to create starburst or flower shape. Other arrangements may be symmetric and/or form a mirror image when bisected along a central axis. The fingers may be triangular, rectangular, oblong, bulbous, tapered, and/or provided with rounded ends. Those shown in FIG. 6B are triangular, tapered, and provided with rounded ends, evenly spaced apart from one another.

In a further embodiment, the projections 133 may actually include or be replaced by a mesh insert at the inlet (i.e., at or near the interface between the dip tube and the fluid carried within the container). The mesh may be similar or identical to the mesh required for foamer/mixing chamber, as this similarity would simplify manufacture. In construction, the mesh consists of interconnected fibrous members which allow for fluid flow while simultaneously blocking large solid particles, such as ice or frozen liquid/product formed in the container at or below the freezing point of the liquid/product.

Piston rod 360 is formed as an elongated shafted extending from its top end proximate mixing chamber 136 to a lower extremity proximate valve 320. Arms or top end enlargement 361 protrude into the chamber 136 and rest on tapered section 303, while at the bottom end a flange 362 interacts with inlet valve 320 and/or cooperating projections on sidewalls 131 proximate the valve 320 or, as shown in FIG. 2A, an insert having retention arms 135 that is attached at this lower-most end of engine 130. Elements 361, 362 define the range of motion for piston rod 360, which is axially displaced relative to the cylinder 131 during actuation to allow liquid to flow from the container into the foaming or mixing chamber 136.

Any combination of the features noted above may be possible. In particular, disclosed aspects may include any combination or permutation of the following:
an actuator head having a stem which extends along a reciprocating axis and an outlet for dispensing foam; and
a pump body coaxially receiving at least a portion of the stem, the pump body having:
a liquid piston allowing fluid to flow through an axial passage therein;
an air piston coaxially receiving and attached to a top portion of the liquid piston;
a piston rod coaxially received within axial passage of the liquid piston;
a pump cylinder encasing both the liquid piston and the air piston and permitting the liquid piston the and air move axially within the pump cylinder along the reciprocating axis;
a foaming chamber defined by interfacing surfaces of the air piston and the liquid piston, the foaming chamber including a liquid inlet and an air inlet positioned proximate to a foaming element;
an air chamber defined by interfacing surfaces of the pump cylinder, the air piston, and the liquid piston, said air chamber varying in volume in response to axial movement of the air piston; and
a valve captured between the liquid piston and the air piston, said valve admitting air from the air chamber along a tortuous passage defined by the interface of the air piston and the top portion of the liquid piston;
a cap, attachable to a container, said cap attached in a sealed manner to the pump cylinder; wherein the tortuous passage includes an apex, said apex positioned at a higher axial elevation than either the liquid inlet or the air inlet so that any fluid accumulating in the foaming chamber cannot flow into the air chamber;
wherein the liquid piston is attached to the air piston by rib-and-groove formations; wherein channels defining the tortuous passage are provided proximate the rib-and-groove formations;
wherein a mesh insert and/or blocking formations are formed at an inlet where fluid is first taken into the pump body;
wherein the cap has a stepped configuration along a bottom facing to form an axial stop for upward movement of the air piston;
wherein ambient air is admitted to the air chamber though a passage formed in or around the cap;
wherein the valve includes an axial wall received in a cylindrical recess formed on the air piston;
wherein the liquid piston includes a radial flange on its outer facing which sealingly engages the valve;
wherein the tortuous passage has an inverted U-shape, an M-shape, or a curved shaped; and
wherein the valve includes an axial wall with flaps positioned on inner and outer facings of the cylindrical wall, said flaps selectively controlling flow of air and liquid around the valve.

All components should be made of materials having sufficient flexibility and structural integrity, as well as a chemically inert nature. The materials should also be selected for workability, cost, and weight. In addition to the materials specifically noted above, common polymers amenable to injection or blow molding, extrusion, or other common forming processes should have particular utility, although metals, alloys, and other composites may be used in place of or in addition to more conventional materials.

References to coupling in this disclosure are to be understood as encompassing any of the conventional means used in this field. This may take the form of snap- or force fitting of components, although threaded connections, bead-and-groove, and slot-and-flange assemblies could be employed. Adhesive and fasteners could also be used, although such components must be judiciously selected so as to retain the underlying design goals inherent to the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Further aspects of the invention may be discerned from careful study of the features illustrated in the drawings. While structures that are most pertinent to the operation are highlighted above, still further functions and structures will be appreciated by skilled persons upon studying the drawings in their entirety.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

The listing of claims replaces all previous versions of the claims:

1. A reciprocating foam dispenser comprising:
an actuator head having a stem which extends along a reciprocating axis and an outlet for dispensing foam; and
a pump body coaxially receiving at least a portion of the stem, the pump body having:
a liquid piston allowing fluid to flow through an axial passage therein;
an air piston coaxially receiving and attached to a top portion of the liquid piston;
a piston rod coaxially received within the axial passage of the liquid piston;
a pump cylinder encasing both the liquid piston and the air piston and permitting the liquid piston and air piston to move axially within the pump cylinder along the reciprocating axis;
a foaming chamber defined by interfacing surfaces of the air piston and the liquid piston, the foaming chamber including a liquid inlet and an air inlet positioned proximate to a foaming element;
an air chamber defined by interfacing surfaces of the pump cylinder, the air piston, and the liquid piston, said air chamber varying in volume in response to axial movement of the air piston; and
a valve captured between the liquid piston and the air piston, said valve admitting air from the air chamber along a tortuous passage defined by the interface of the air piston and the top portion of the liquid piston;
wherein the tortuous passage includes an apex, said apex being positioned at a higher axial elevation than either the liquid inlet or the air inlet so that any fluid accumulating in the foaming chamber cannot flow into the air chamber.

2. The dispenser of claim 1 wherein the liquid piston is attached to the air piston by rib-and-groove formations.

3. The dispenser of claim 2 wherein channels defining the tortuous passage are provided proximate the rib-and-groove formations.

4. The dispenser of claim 1, wherein a mesh insert and/or blocking formations are formed at an inlet where fluid is first taken into the pump body.

5. The dispenser of any one of claim 1, comprising a cap, attachable to a container, said cap being attached in a sealed manner to the pump cylinder.

6. The dispenser of claim 5 wherein the cap forms an axial stop for upward movement of the air piston.

7. The dispenser of claim 6 wherein the cap has a stepped configuration at a bottom facing to form the axial stop.

8. The dispenser of claim 5 wherein ambient air is admitted to the air chamber though a passage formed in or around the cap.

9. The dispenser of claim 5, wherein the valve includes an axial wall received in a cylindrical recess formed on the air piston.

10. The dispenser of claim 1, wherein the liquid piston includes a radial flange on its outer facing which sealingly engages the valve.

11. The dispenser of claim 10, wherein the tortuous passage has an inverted U-shape, an M-shape, or a curved shape.

12. The dispenser of claim 10, wherein the valve includes an axial wall with flaps positioned on inner and outer facings of the cylindrical wall, said flaps selectively controlling flow of air around the valve.

13. The dispenser of claim 1, wherein the tortuous passage has an inverted U-shape, an M-shape, or a curved shape.

14. The dispenser of claim 1, wherein the valve includes an axial wall with flaps positioned on inner and outer facings of the cylindrical wall, said flaps selectively controlling flow of air around the valve.
